(19) United States
(12) Patent Application Publication
(10) Pub. No.: US 2010/0163740 A1
(43) Pub. Date: Jul. 1, 2010

(54) RADIATION DETECTION APPARATUS

(75) Inventor: Hideharu Matsuura, Osaka (JP)

Correspondence Address: FOLEY & LARDNER LLP, 150 EAST GILMAN STREET, P.O. BOX 1497, MADISON, WI, 53701-1497, US

(73) Assignee: Osaka Electro-Communication University

(21) Appl. No.: 12/665,485

(22) PCT Filed: Aug. 10, 2007
(86) PCT No.: PCT/JP2007/065728

§ 371 Date: Dec. 18, 2009

(51) Int. Cl. G01T 1/24

(52) U.S. Cl. 250/370.13; 250/370.12; 250/370.14

(57) ABSTRACT

A semiconductor substrate is composed of a SiC crystal. A metal film having a desired area and serving as an incident surface onto which X-rays are made incident is formed on one surface of the semiconductor substrate. An electrode having the shape of a circle is formed at the central portion of the other surface of the semiconductor substrate. A ring-shaped electrode is formed in a portion near the circumference of the semiconductor substrate so as to surround the electrode. A predetermined direct voltage is applied to the metal film and the ring-shaped electrode. A voltage of a ground level is applied to the electrode. X-rays (γ-rays) that are made incident onto the metal film cause the generation of electron-hole pairs in the semiconductor substrate. The generated electrons are collected at the electrode and drawn as electric signals from an output terminal.

### TECHNICAL FIELD

The present invention relates to a radiation detection apparatus, and in particular, to a radiation detection apparatus including a semiconductor device serving as a detection medium.

### BACKGROUND ART

A radiation detector is disclosed in which a P-type semiconductor crystal is formed on one surface of a silicon (Si) semiconductor substrate, an N-type semiconductor crystal is formed on the other surface thereof, and metal electrodes are formed outside the P-type semiconductor crystal and the N-type semiconductor crystal. The radiation detector is configured to detect radiation by applying a voltage between the electrodes, turning the entire Si semiconductor substrate into a depletion layer, and measuring charge generated in the depletion layer region by the radiation incident on the Si semiconductor substrate (see Patent Document 1).

Patent Document 1: Japanese Patent Application Laid-Open No. 6-120549 (1994)

### BRIEF DESCRIPTION OF THE DRAWINGS

FIG. 1 is a perspective view showing a main part of a radiation detection apparatus according to First embodiment;

FIG. 2 is a sectional view showing a main part of the radiation detection apparatus according to First embodiment;

FIG. 3 is an explanatory view showing an example of the concentrations of impurities contained in a semiconductor substrate;

FIG. 4 is a sectional view showing a main part of a radiation detection apparatus according to Second embodiment;

FIG. 5 illustrates plan views showing a main part of a radiation detection apparatus according to Third embodiment;

FIG. 6 illustrates plan views showing a main part of a radiation detection apparatus according to Fourth embodiment; and

FIG. 7 is a sectional view showing a main part of a radiation detection apparatus according to Fifth embodiment.

### EXPLANATION OF CODES

1 semiconductor substrate
2 metal film (electrode)
3, 4 electrode
5 electrode
21 P layer (cathode)
22 N layer (anode)
23 P layer
24, 25, 26 electrode

### BEST MODE FOR CARRYING OUT THE INVENTION

### First Embodiment

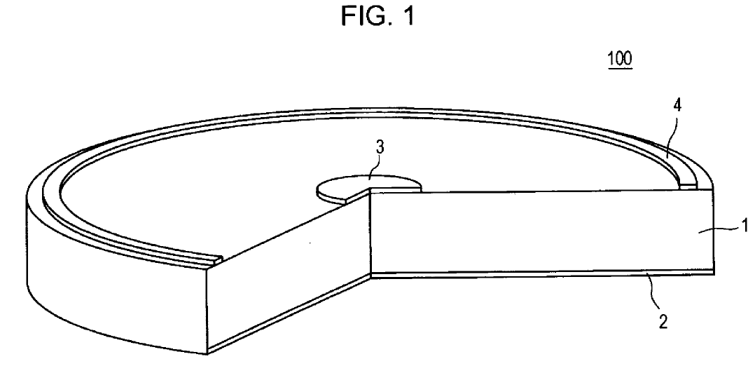

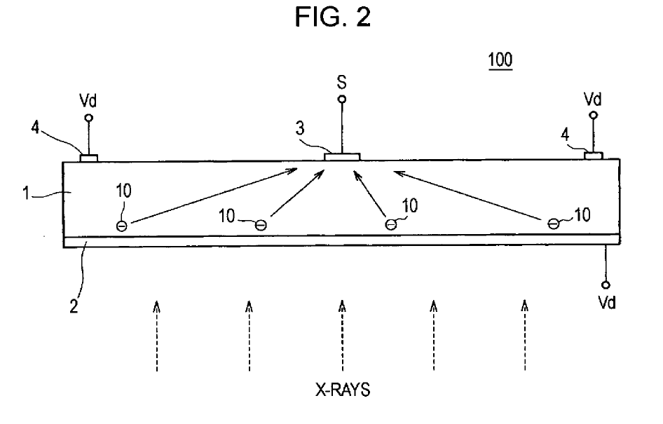

FIG. 1 is a perspective view showing a main part of a radiation detection apparatus 100 according to First embodiment. FIG. 2 is a sectional view showing a main part of the radiation detection apparatus 100 according to First embodiment. In FIG. 1, code 1 denotes a semiconductor substrate serving as a radiation detection device for X-rays, γ-rays, α-rays, or the like. The semiconductor substrate 1 is composed of a crystal of silicon carbide (hereinafter, referred to as “SiC”). The semiconductor substrate 1 is a wafer having a desired diameter (for example, 2 to 3 inches) or a plate-like piece cut from a wafer, and has a planar shape of a circle. Note that the planar shape is not restricted to a circle and may be a desired shape such as a rectangle.

A metal film 2 having a desired area and serving as an incident surface on which X-rays are made incident (also serving as an electrode) is formed on one surface of the semiconductor substrate 1. The metal film 2 is composed of a material, for example, Ni (nickel). However, the material is not restricted thereto and may be a metal such as Ti, Au, Pt, Al, or the like.

An electrode 3 having the shape of a circle is formed at the central portion of the other surface of the semiconductor substrate 1. An electrode 4 having the shape of a ring is formed in a portion near the circumference of the semiconductor substrate 1 so as to surround the electrode 3. That is, the electrode 3 and the ring-shaped electrode 4 are disposed so as to correspond to the position of the metal film 2. The electrodes 3 and 4 are composed of a material similar to that of the metal film 2. As shown in FIG. 2, a predetermined direct voltage Vd (for example, about −100 V to −1000 V) is applied to the metal film 2 and the ring-shaped electrode 4. A voltage of a ground level is applied to the electrode 3. Note that different voltages may be applied to the metal film 2 and the electrode 4.

An interaction such as the photoelectric effect, Compton scattering, which is scattering of X-rays caused by particles (electrons), or generation of electron-positron pairs occurs between X-rays (γ-rays) and bound electrons in a material. As a result, the bound electrons that have received energy move in the material and thereby causing the generation of electrons or holes. Such electrons or holes are drawn as current, and thereby allowing the detection of X-rays (γ-rays).

X-rays (γ-rays) that have been made incident on the metal film 2 cause the generation of electron-hole pairs in the semiconductor substrate 1. The application of the predetermined voltage Vd to the metal film 2 and the electrode 4 provides a potential gradient in which the potential difference increases from a portion near the circumference to the central portion in the semiconductor substrate 1. Thus, the generated electrons 10 are collected at the electrode 3. The electrons 10 (charge) collected at the electrode 3 are drawn as electric signals from an output terminal S and output to an amplifier (not shown). The amplifier (not shown) is configured to amplify the input electric signals and thereby output a voltage corresponding to the number of generated electrons to a multichannel pulse height analyzer (not shown). Thus, the distribution of the energy of the X-rays can be analyzed.

The semiconductor substrate 1 has a thickness of, for example, about 0.37 mm. However, the thickness is not restricted thereto and the semiconductor substrate 1 may have a thickness in the range of 0.3 to 10 mm depending on the energy of X-rays (γ-rays) to be detected. When the semiconductor substrate 1 has a thickness of less than 0.3 mm, X-rays having high energy are likely to be transmitted through the semiconductor substrate 1 and the accuracy with which X-rays are detected is degraded. When the thickness is more than 10 mm, the detection efficiency of X-rays having high energy does not change, and the cost of the apparatus is increased. Accordingly, the semiconductor substrate 1 is preferably made to have a thickness of 0.3 mm or more and 10 mm or less in accordance with the X-rays to be detected.

The semiconductor substrate 1 has high purity, a semi-insulating property, and a resistivity of 1×10⁶Ωcm or more and 1×10¹⁴Ωcm or less. When the resistivity is less than 1×10⁶Ωcm, the leakage current cannot be controlled to a small value upon the application of a voltage to the semiconductor substrate 1. In particular, when the ambient temperature is about room temperature, a large leakage current is generated and the accuracy with which X-rays are detected is degraded. Since the semiconductor substrate has the resistivity of 1×10⁶Ωcm or more, the leakage current can be controlled to a small value even when the absolute value of a voltage applied to the metal film 2 and the electrode 4 is made large. Accordingly, the semiconductor substrate 1 can be made to have a large thickness and the spectral range of X-rays (γ-rays) to be detected can be widened. Thus, various types of X-rays can be detected. When the resistivity is more than 1×10¹⁴Ωcm, the semiconductor substrate 1 does not have a semi-insulating property but a completely-insulating property. Accordingly, the semiconductor substrate 1 preferably has a resistivity in the range of 1×10⁶Ωcm to 1×10¹²Ωcm.

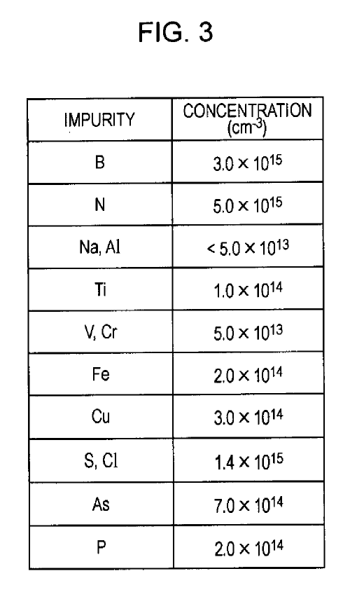

FIG. 3 is an explanatory view showing an example of the concentrations of impurities contained in the semiconductor substrate 1. The concentrations of impurities contained in the semiconductor substrate (SiC) 1 of high purity can be determined with, for example, a secondary ion mass spectrometer. As shown in FIG. 3, for example, the concentration of B (boron) contributing to an acceptor level is 3.0×10¹⁵ cm⁻³. The concentration of N (nitrogen) contributing to a donor level is 5.0×10¹⁵ cm⁻³.

The concentrations of Ti (titanium), V (vanadium), Cr (chromium), Fe (iron), and Cu (copper) that contribute to a deep level (for example, an energy level formed in the middle of a band gap) are respectively 1.0×10¹⁴ cm⁻³, 5.0×10¹³ cm⁻³, 5.0×10¹³ cm⁻³, 2.0×10¹⁴ cm⁻³, and 3.0×10¹⁴ cm⁻³. Note that the elements serving as impurities and the concentrations of the elements are mere examples and are not limited thereto.

When a voltage is applied to the semiconductor substrate 1, thermally excited electrons/holes are shifted to a conduction band beyond an energy gap (also referred to as a forbidden band or a band gap; SiC has an energy gap of about 2.2 to 3.26 eV.), which generates a leakage current. When X-rays are detected with the semiconductor substrate 1, such leakage current can be noise in a circuit system for detecting X-rays. Another leakage current is generated because the presence of impurities in the semiconductor substrate 1 generates a new energy level in the middle of the energy gap, which facilitates the shift of thermally excited electrons/holes. However, the semiconductor substrate 1 of First embodiment has a wide energy gap and high purity, that is, the concentrations of the contained impurities are considerably low as shown in the example in FIG. 3. Accordingly, the leakage current is on the order of 1 pA or less.

As described above, the leakage current is a considerably small value of 1 pA or less even when the ambient temperature is room temperature. Accordingly, a cooling apparatus (for example, liquid He, liquid nitrogen, a Peltier element, or the like) for keeping the ambient temperature low so as to reduce leakage current is not necessary.

The leakage current is reduced (to 1 pA or less), and therefore, noise can be considerably reduced and the accuracy with which X-rays are detected can be enhanced.

The absolute value of a voltage applied to the metal film 2 and the electrode 4 is increased, and therefore, the potential gradient in the semiconductor substrate 1 can be increased and the transfer rate of electrons/holes can be increased to thereby enhance the energy resolution for detecting X-rays. Note that the energy resolution is an evaluation value that allows the detection of the energy level of X-rays (γ-rays) at high accuracy. The energy resolution in terms of full width at half maximum (FWHM) corresponds to an energy width at half of the height of the peak value. The smaller the FWHM is, the better the resolution is.

As for impurities in the semiconductor substrate 1 according to First embodiment, the concentration of N (nitrogen) contributing to a donor level and the concentration of B (boron) contributing to an acceptor level is 1×10¹⁶ cm⁻³ or less, preferably 1×10¹⁵ cm⁻³ or less, and most preferably 1×10¹⁴ cm⁻³ or less. The concentration of N (nitrogen) contributing to a donor level and the concentration of B (boron) contributing to an acceptor level are 1×10¹⁵ cm⁻³ or less, and therefore, the leakage current can be decreased. Moreover, the concentration of N (nitrogen) contributing to a donor level and the concentration of B (boron) contributing to an acceptor level are 1×10¹⁴ cm⁻³ or less, and therefore, the leakage current can be further decreased.

The concentration of P (phosphorus) or As (arsenic) contributing to a donor level and the concentration of Al (aluminum) contributing to an acceptor level are 1×10¹⁵ cm⁻³ or less, preferably 1×10¹⁴ cm⁻³ or less, and most preferably 1×10¹³ cm⁻³ or less. The concentration of P (phosphorus) or As (arsenic) contributing to a donor level and the concentration of Al (aluminum) contributing to an acceptor level are 1×10¹⁴ cm⁻³ or less, and therefore, the leakage current can be decreased. Moreover, the concentration of P (phosphorus) or As (arsenic) contributing to a donor level and the concentration of Al (aluminum) contributing to an acceptor level are 1×10¹³ cm⁻³ or less, and therefore, the leakage current can be further decreased.

The concentration of V (vanadium), Cr (chromium), Fe (iron), Cu (copper), or Ti (titanium) that contributes to a deep level is 1×10¹⁵ cm⁻³ or less, preferably 1×10¹⁴ cm⁻³ or less, and most preferably 1×10¹³ cm⁻³ or less.

To achieve the above-described concentrations of impurities, no doping of N (nitrogen), P (phosphorus), As (arsenic), B (boron), Al (aluminum), and the like serving as dopants is conducted in the semiconductor substrate 1 according to First embodiment. The semiconductor substrate 1 (SiC) has a low intrinsic carrier density (for example, about 10⁻⁸ cm⁻³). Since the semiconductor substrate 1 has a low carrier density even at room temperature, the semiconductor substrate 1 can be made to have high resistivity without doping of an impurity contributing to a deep level. In First embodiment, a process for doping is not necessary.

### Second Embodiment

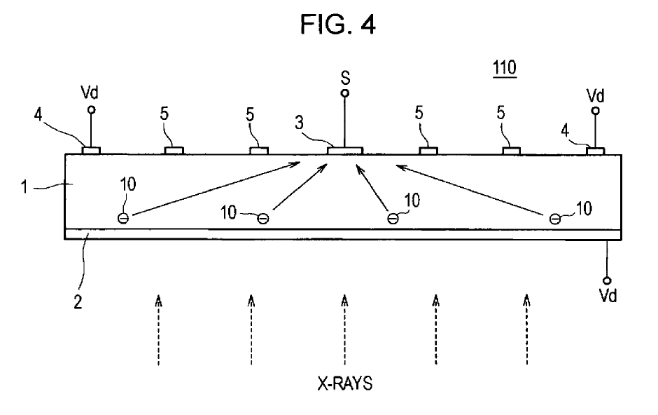

FIG. 4 is a sectional view showing a main part of a radiation detection apparatus 110 according to Second embodiment. The difference from the radiation detection apparatus 100 according to First embodiment is that one or a plurality of electrodes 5 having the shape of a ring are formed between the electrode 3 and the ring-shaped electrode 4. Specifically, the ring-shaped electrode(s) 5 is/are disposed around the electrode 3 so as to be concentric with the ring-shaped electrode 4. Note that like codes are used to denote elements equivalent to those in First embodiment and descriptions of these elements are omitted.

The electrode(s) 5 is/are composed of a material similar to that of the electrodes 3 and 4. No voltage is applied to the electrode(s) 5. The electrode(s) 5 is/are placed at an appropriate distance from neighboring electrode(s), and therefore, the potential gradient along the radius of the semiconductor substrate 1 can be adjusted and the potential gradient can be made uniform. As a result, electrons 10 generated in the semiconductor substrate 1 can be made likely to be collected at the electrode 3 and the efficiency of charge collection can be further enhanced. To further adjust the potential gradient, a voltage may be applied to the electrode(s) 5.

### Third Embodiment

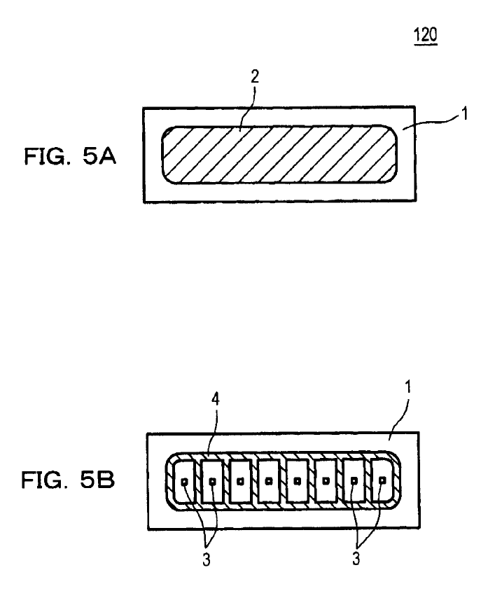

FIG. 5 illustrates plan views showing a main part of a radiation detection apparatus 120 according to Third embodiment. The difference from First and Second embodiments is that a plurality of electrodes 3 for drawing electrons (charge) are arranged in a line. As shown in FIG. 5(a), the metal film 2 having the shape of a rectangle is formed on one surface of the semiconductor substrate 1 having the shape of a rectangle. The metal film 2 serves as an incident surface onto which X-rays (γ-rays) are made incident.

As shown in FIG. 5(b), the plurality of electrodes 3 are arranged in a line at an appropriate distance within the region corresponding to the metal film 2 on the other surface of the semiconductor substrate 1. Electrodes 4 having the shape of a ring (rectangle) are formed around the electrodes 3 so as to surround the electrodes 3. The electrodes 3 are each surrounded by one of the ring-shaped electrodes 4. A predetermined voltage Vd is applied to the metal film 2 and the electrodes 4. Different voltages may be applied to the metal film 2 and the electrodes 4.

Thus, electrons generated by X-rays incident on a region surrounded by one ring-shaped electrode 4 are collected at the electrode 3 surrounded by the electrode 4. Electric signals are drawn from output terminals connected to the electrodes 3, and therefore, the energy of the X-rays and the intensity of the X-rays can be detected so as to be associated with one-dimensional positional information.

In the example shown in FIG. 5, neighboring ring-shaped (rectangle-shaped) electrodes 4 share portions thereof with each other. However, the present invention is not limited to such a configuration, and the ring-shaped electrodes 4 formed around the electrodes 3 may be separate from each other. The shape of the electrodes 4 is not limited to the example shown in FIG. 5 and the electrodes 4 may have another shape such as a circle.

### Fourth Embodiment

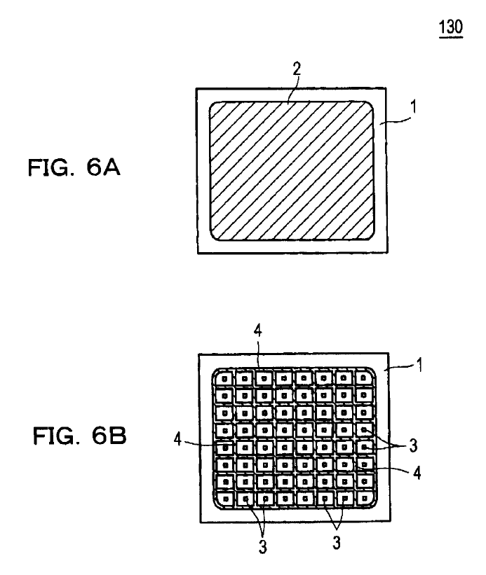

FIG. 6 illustrates plan views showing a main part of a radiation detection apparatus 130 according to Fourth embodiment. The difference from First to Third embodiments is that a plurality of electrodes 3 for drawing electrons (charge) are arranged in a matrix. As shown in FIG. 6(a), the metal film 2 having the shape of a rectangle is formed on one surface of the semiconductor substrate 1 having the shape of a rectangle. The metal film 2 serves as an incident surface onto which X-rays (γ-rays) are made incident.

As shown in FIG. 6(b), the plurality of electrodes 3 are arranged in a matrix at an appropriate distance within the region corresponding to the metal film 2 on the other surface of the semiconductor substrate 1. Electrodes 4 having the shape of a ring (rectangle) are formed around the electrodes 3 so as to surround the electrodes 3. The electrodes 3 are each surrounded by one of the ring-shaped electrodes 4. A predetermined voltage Vd is applied to the metal film 2 and the electrodes 4. Different voltages may be applied to the metal film 2 and the electrodes 4.

Thus, electrons generated by X-rays incident on a region surrounded by one ring-shaped electrode 4 are collected at the electrode 3 surrounded by the electrode 4. Electric signals are drawn from output terminals connected to the electrodes 3, and therefore, the energy of the X-rays and the intensity of the X-rays can be detected so as to be associated with two-dimensional positional information.

In the example shown in FIG. 6, neighboring ring-shaped (rectangle-shaped) electrodes 4 share portions thereof with each other. However, the present invention is not limited to such a configuration, and the ring-shaped electrodes 4 formed around the electrodes 3 may be separate from each other. The shape of the electrodes 4 is not limited to the example shown in FIG. 6 and the electrodes 4 may have another shape such as a circle or a triangle.

### Fifth Embodiment

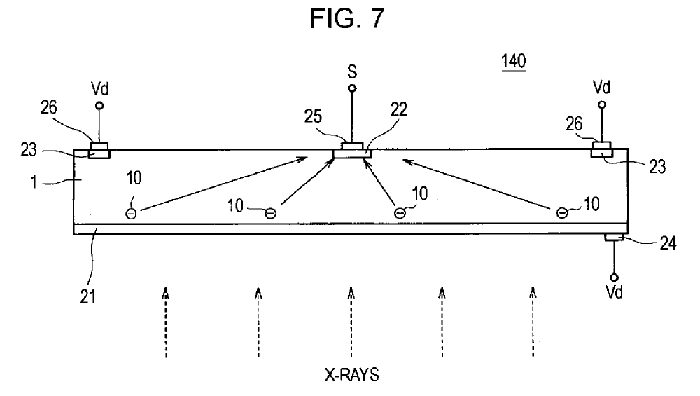

FIG. 7 is a sectional view showing a main part of a radiation detection apparatus 140 according to Fifth embodiment. The difference from First embodiment is that a P layer (cathode) 21 serving as an incident surface onto which X-rays are made incident is formed on a surface of the semiconductor substrate 1; an N layer (anode) 22 is formed in the central portion of the other surface of the semiconductor substrate 1; and a P layer 23 having the shape of a ring is formed around the N layer 22.

Electrodes 24 and 26 for applying a predetermined voltage Vd are formed on the P layers 21 and 23. An electrode 25 for drawing electrons 10 generated in the semiconductor substrate 1 is formed on the N layer 22. In Fifth embodiment, a doping process for forming the P layers 21 and 23 and the N layer 22 is necessary.

To adjust the potential gradient in the semiconductor substrate 1 and make it uniform also in Fifth embodiment, P layer(s) can be formed concentrically in the position(s) of the electrode(s) 5 according to Second embodiment. In Third and Fourth embodiments, a P layer (cathode) may be formed instead of the metal film 2 on the semiconductor substrate 1; N layers (anodes) may be formed in the positions of the electrodes 3 on the other surface of the semiconductor substrate 1; and ring-shaped P layers may be formed in the positions of the ring-shaped electrodes 4.

As described so far, the radiation detection apparatuses according to the embodiments comprises a semiconductor substrate (for example, SiC) having high purity and a semi-insulating property, and thereby the leakage current can be made a considerably small value. Additionally, a high voltage can be applied to the semiconductor substrate while the leakage current is controlled. Accordingly, the accuracy with which X-rays are detected and energy resolution can be enhanced to a practical level even when the ambient temperature is about room temperature.

The energy of X-rays radiating from a heavy metal such as Pb, Cd, Hg, or Cr is high. However, since, in the radiation detection apparatuses according to the embodiments, each semiconductor substrate has high resistivity and a considerably low leakage current, the semiconductor substrate can be made to have a desired thickness. Accordingly, even when X-rays having high energy radiated from the above-described materials are made incident onto the semiconductor substrate, the energy of the X-rays can be detected at sufficiently high accuracy by absorbing the X-rays with the semiconductor substrate without allowing the X-rays to be transmitted through the semiconductor substrate. Additionally, the radiation detection apparatuses according to the embodiments can be configured to be operable at room temperature without being cooled with liquid He, liquid nitrogen, a Peltier element, or the like. Thus, apparatuses that have a small size or are portable can be achieved, which facilitates the detection of X-rays not only indoors but also outdoors.

According to the embodiments, the positions onto which X-rays are made incident (one-dimensional positional information, two-dimensional positional information, and the like), the energy of the X-rays, and the intensity of the X-rays can be all simultaneously detected. Such embodiments are widely applicable to high-energy X-ray detection apparatuses such as a portable fluorescent X-ray analyzer, a medical CT (computer tomography) apparatus, an X-ray microscope, and an X-ray astronomical telescope. Additionally, SiC has excellent resistance to radiation, the embodiments can also be applied to detection of α-rays.

In the above-described First to Fifth embodiments, the crystalline structure (polytype) of SiC is not particularly restricted and the crystalline structure may be 4H—SiC, 6H—SiC, 3C—SiC, 15R—SiC, or the like.

In the above-described First to Fifth embodiments, the semiconductor substrate 1 is not restricted to SiC and the semiconductor substrate 1 may be composed of a semiconductor having a wider energy gap than silicon, such as gallium arsenide (GaAs), diamond, cadmium telluride, or mercuric iodide (HgI₂) as long as the resultant substrate has a high density and a semi-insulating property.

1-9. (canceled)

10. A radiation detection apparatus for detecting radiation based on a charge generated by the incident radiation, comprising:
a semiconductor substrate having purity equal to or higher than predetermined purity;
an incident surface provided on one surface of the semiconductor substrate, and through which radiation is incident; and
an electrode provided on the other surface of the semiconductor substrate, and which collects a charge.

11. The radiation detection apparatus according to claim 10, wherein the semiconductor substrate has a resistivity of 1×10⁶Ωcm or more and 1×10¹⁴Ωcm or less.

12. The radiation detection apparatus according to claim 10, wherein the semiconductor substrate contains an impurity contributing to a donor level or an acceptor level in a concentration of 1×10¹⁶ cm⁻³ or less.

13. The radiation detection apparatus according to claim 12, wherein the semiconductor substrate contains an impurity contributing to a deep level in a concentration of 1×10¹⁵ cm⁻³ or less.

14. The radiation detection apparatus according to claim 10, wherein the semiconductor substrate has a thickness ranging from 0.3 mm or more to 10 mm or less.

15. The radiation detection apparatus according to claim 10, wherein the semiconductor substrate is selected from the group of silicon carbide, gallium arsenide, cadmium telluride, diamond, and mercuric iodide.

16. The radiation detection apparatus according to claim 10, further comprising a ring-shaped electrode for applying a voltage around the electrode so as to be separate from the electrode.

17. The radiation detection apparatus according to claim 16, wherein the electrode and the ring-shaped electrode are provided in positions corresponding to the incident surface.

18. The radiation detection apparatus according to claim 10, wherein a plurality of the electrodes are provided with a distance therebetween, and
further comprising a ring-shaped electrode for applying a voltage around the electrodes so as to be separate from the electrodes.

19. The radiation detection apparatus according to claim 18, wherein the electrodes and the ring-shaped electrode are provided in positions corresponding to the incident surface.
